(19) United States
(12) Patent Application Publication
(10) Pub. No.: US 2007/0020591 A1
(43) Pub. Date: Jan. 25, 2007

(54) Methods and aids for teaching Arabic to the blind

(76) Inventor: Sheikha Lateefah Fahed AlSalem AlSabah, Al-Shaab Palace (KW)

Correspondence Address: LOWE HAUPTMAN BERNER, LLP, 1700 DIAGONAL ROAD, SUITE 300, ALEXANDRIA, VA, 22314, US

(21) Appl. No.: 11/186,798

(22) Filed: Jul. 22, 2005

(51) Int. Cl. G09B 1/00

(52) U.S. Cl. 434/159

(57) ABSTRACT

A method for teaching Arabic to the blind includes the steps of synopsizing 82 shapes representing 28 basic letters into 32 shapes and then consolidating the 32 shapes into 10 groups according to shape in a first phase of a program. In a second phase of the program dots are added to distinguish each individual letter within a group. Then, in the third phase, a student learns to add pronunciation and vowelization signs. Optimizing the letters proportionally to conform with spatial visualization for the blind. Further, angles and curves are used to denote the start and end of a word. Teaching aids and apparatus for teaching and communicating in Arabic to and with the blind are also disclosed.

### FIELD OF THE INVENTION

This invention relates to methods and aids for teaching the Arabic language and more particularly to methods and aids for teaching the Arabic language to the blind. The invention also relates to an Arabic teaching aid wherein 82 shapes representing 28 basic letters are synopsized into 32 shapes.

### BACKGROUND FOR THE INVENTION

Braille is a code which enables blind persons to read and write according to the International Braille Research Center. As reported, it was invented by Louis Braille in 1829 and is made up of a rectangular six-dot cell with up to 63 possible combinations using one or more of six dots. In use, Braille is embossed onto thick paper and read with the fingers. A combination of Braille dots within a cell represent contractions of two or more print letters. Therefore, Braille characters take up to three times as much space as print.

As reported by the International Braille Research Center, Braille is the only reliable method of literacy for blind persons. However, Braille is not without shortcomings. For example, there is a shortage of qualified teachers of the blind who know Braille and teach it, the English Braille code needs updating to keep pace with the information explosion, and there are separate codes for mathematics, scientific notation and computers which make Braille confusing to learn and use. Further, it appears that the blind are putting more emphasis on tape recorders and computers at the expense of reading knowledge.

There are other disadvantages in the use of Braille. For example, the use of Braille tends to segregate the blind from the non-blind who cannot read or write in Braille. Further, Braille is derived from French and has been developed in English and Latin based languages but excludes vowelization signs and vocalization marks that are characteristic of the Arabic language. This fact has impeded its spread and lowers its acceptability in the Arab countries.

Notwithstanding the widespread use of Braille, there is a long felt need for an improved method for communications by the blind in Arabic. There is a long felt need for a method for communication that serves the calligraphy characteristics of the Arabic language. Further, there is a need for a language that can be readily read and understood by the blind and the non-blind. In addition, there is a need for an improved method and teaching aids for teaching Arabic to the blind. These needs and other advantages will be met by the methods and aids for teaching Arabic to the blind in accordance with the present invention.

### BRIEF SUMMARY OF THE INVENTION

In essence, the present invention contemplates a method for teaching the Arabic language to the blind and for enabling the blind to communicate in Arabic, to read Arabic and write or print Arabic letters that can be readily read and understood by persons with and without normal vision. The method includes the steps of synopsizing 82 shapes representing 28 basic letters into 32 shapes and then consolidating the 32 shapes into 10 groups according to shape in a first phase of a program. This synopsizing and grouping of the shapes or letters facilitates teaching and learning for a blind individual. In a second phase of the program indicia such as dots are added to the shapes in order to distinguish each individual letter within a group. Then, when an individual or student has mastered or is at least familiar with the above steps, pronunciation and vocalization signs are added in a third phase of the program. Finally, angles and/or curves are added to denote the start of or end of a word.

In a second embodiment of the invention, a teaching aid for teaching Arabic to the blind includes a synopsized Arabic alphabet wherein 82 shapes representing 28 basic letters are synopsized into 32 shapes. These 32 shapes form the basis for learning to read and write in Arabic.

A third embodiment of the invention contemplates a method for communication that can be read and understood by the blind and those that are not visually impaired. The method includes the step of synopsizing some 82 Arabic characters or shapes representing 28 basic Arabic letters into 32 synopsized shapes. In a second and third step a message is developed using the 32 synopsized shapes and printed using raised printing that can be read by the blind and the non-blind.

The invention also contemplates a fourth embodiment wherein an Arabic typewriter and teaching aid incorporates a word processor. In this embodiment, the word processor includes a keyboard having 32 “letter” keys representing a synopsized alphabet wherein 82 shapes representing 28 basic letters are synopsized into 32 shapes. Audio means pronounce an Arabic letter that corresponds to a struck “letter” key. The word processor includes a keyboard and means such as a backspace key for erasing a letter that was struck in error. Means such as a space bar or angle key indicates the end of a word and audio means then pronounces the word. In addition, the keyboard indicates a word erase key for deleting a wrong word. In its preferred form, the word processor is programmed to recognize the end of a sentence and to include audio means to read the sentence out loud to the typist. The typist then has the alternative to erase the sentence or print it with raised letters that can be read by a blind person by tracing the letters with his fingers and by a person with normal vision by sight.

The invention will now be described in connection with the accompanying drawings wherein like reference numerals are used to indicate like steps.

### DESCRIPTION OF THE DRAWINGS

FIG. 1 illustrates a synopsized version of the Arabic letters and symbols wherein 82 shapes representing 28 basic letters have been synopsized into 32 shapes;

FIG. 2 is a table that illustrates the grouping of the synopsized Arabic letters used in teaching Arabic to the blind;

FIG. 3 is a block diagram illustrating a method for teaching Arabic to the blind;

FIG. 4 is a block diagram illustrating a method for communication by the blind in the Arabic language; and,

FIG. 5 is a block diagram illustrating an Arabic typewriter and teaching aid for teaching Arabic to the blind.

### DESCRIPTION OF THE PREFERRED EMBODIMENTS OF THE INVENTION

Today, we are all living in an age of information wherein knowledge and technology are being rapidly advanced and/or expanded. For many, our way of life is based on our knowledge and on an ability to assimilate rapidly changing information and an ability to use that knowledge for the benefit of ourselves and others. However for many bright and articulate individuals who are visually impaired, the advances in knowledge and technology may not be readily available. For example, information in Braille or various raised codes, methods of production and writing devices may lag from information in current articles and other reading materials.

The problems encountered by the visually impaired are further exacerbated in the Arabic world and for those who communicate in the Arabic language. Such problems begin with the teaching of Arabic and more particularly with teaching the blind to read and write in Arabic. Accordingly, the present invention addresses the need for an improved method for communicating in Arabic that can be written and read by the blind as well as those who are not visually impaired.

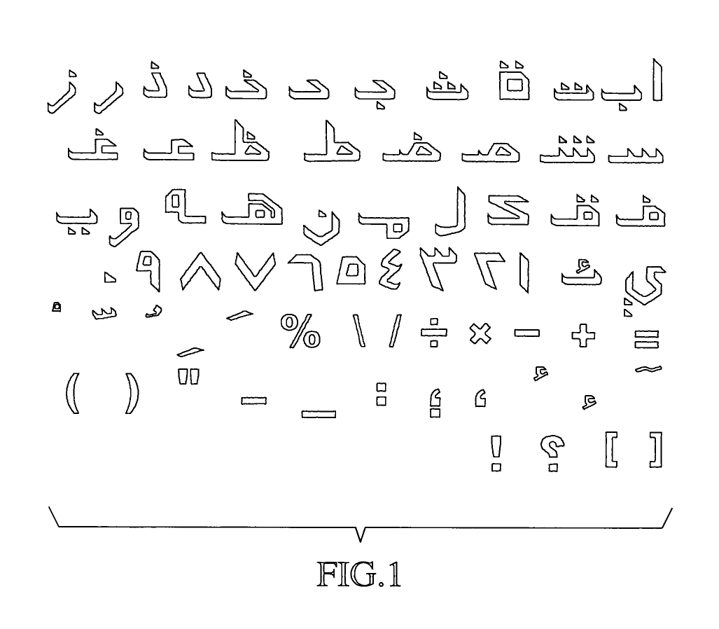

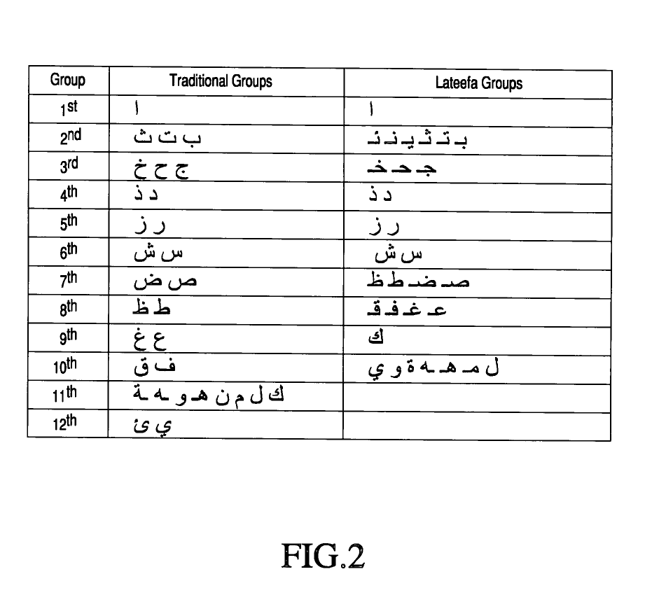

As shown in FIG. 1, 82 Arabic letters have been synopsized into 32 shapes which represents 28 basic letters. The 32 shapes are then consolidated into 10 groups which correspond to a traditional grouping of Arabic letters as shown in FIG. 2. The 32 synopsized shapes are used in teaching communication in Arabic to the blind.

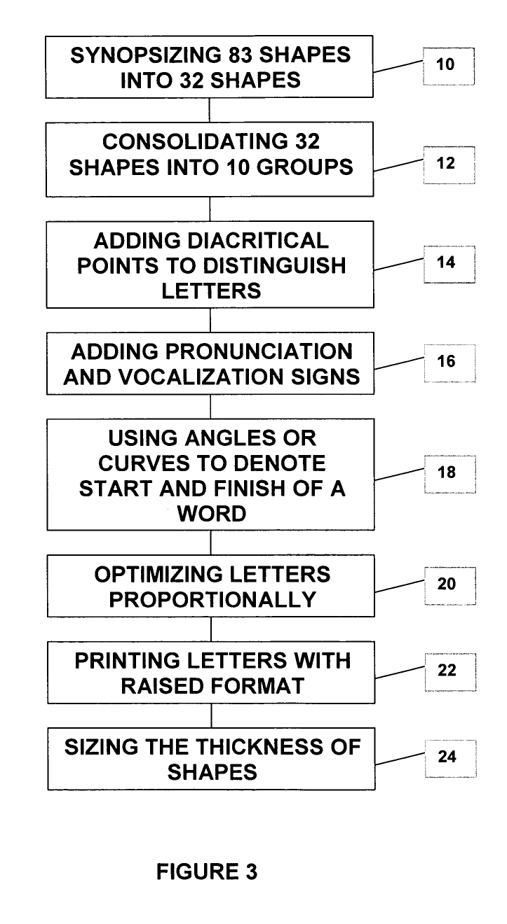

For example, as shown in FIG. 3 a method for teaching Arabic to the blind includes the steps of synopsizing 82 shapes into 32 shapes in step 10. The 82 shapes are well recognized in the Arabic world and are not repeated herein. The 32 shapes are then consolidated into 10 groups of similar letters in step 12. In step 14 indicia such as dots are added to distinguish similar letters in a group and in step 16 pronunciation and vocalization signs are added.

In Arabic most of the letters take different shapes when constituting the first letter of a word, the last letter, or the one in between. However, in the present invention, a single shape is used. In addition, some letters which are identical in form are distinguished from one another with the aid of small dots called diacritical points which have been added in step 14.

As a student progresses, the pronunciation or vocalization signs are added in step 16. The Arabic language originally had no signs for short vowels. However, when the Arabic language was learned by non-Arabs and when the verses of the Qur'an were read incorrectly, these signs came to be used. As a result Arabic consonants are provided with a vowel sign which are sometimes indicated as will be well understood by persons of ordinary skill in the Arabic language.

To be more specific there are three short vowels in the Arabic language. Unlike English, vowels in Arabic are indicated by strokes.

For example, Fatha (a) is a small diagonal stroke above a consonant and is identical with the vowel “a” in the English word “man”;

Damma (u) is a small [symbol] waw above a consonant and is identical with the vowel “u” in the English word “bull”; and

Kasra (i) is a small diagonal stroke under a consonant and is identical with “i” in the English word “finish.”

In addition, when nouns and adjectives are indefinite, the vowel signs are written double. In those cases the pronunciation of the word changes. For example, a letter with one “Fatha” is pronounced as “ba,” but the same letter with a double “Fatha” is pronounced as “ban.”

Pronunciation of an Arabic word can also be indicated by a double consonant. For example, when a consonant occurs twice with a vowel sound in between it is written once and a sign referred to as a Shadda is placed over it. However, a double consonant receives a Shadda only when a vowel precedes it. Further the vocal sign is placed over the diacritical point in the event of a “Fatha” or “Damma” but underneath if the vowel is “Kasra.”

The changing shape of the Arabic alphabet adds to the complexity of the language. For example, a letter is written in a different form according to whether it stands alone, constitutes an initial letter, is joined to a preceding or following letter or constitutes the final letter in a word. However, this complexity has been eliminated by the use of the synopsized letters in accordance with the present invention.

In step 18 angles or curves are used to denote the start or end of the word. The words are of course written from right to left as opposed to English which proceeds from left to right. The direction of the angle leads the reading finger of the blind. For example, letters coming at the start of a word are directed to the right while letters coming at the end of a word will have the tail angle looking to the left and preferably highly embossed so that a blind person will note that it is the end of a word. For figures, in some letters like the “Alef,” the same shape will be inverted to denote variably the start and end of words in harmony with the direction of the angle.

The pronunciation and vocalization marks “the second half of the fifth row and the first half of the sixth row” in FIG. 2 are diacritics. They are above or below the letter that symbolize the correct pronunciation of the latter and the vowels.

The method in accordance with the present invention also contemplates optimizing letters proportionally that can form with spatial visualization for the blind in step 20. In other words, the size of the letters are sufficient for a blind person to readily read and distinguish letters by touch but still relatively small in order to obtain a reasonable amount of information on a given space.

After optimizing the letters in step 20, the letters and/or words are printed with a raised format in step 22. Conventional techniques for printing raised letters are well known and may be used in the practice of the present invention. Similarly, conventional printing inks for printing raised letters are known and may be used. Such inks may be heat activated and dried, UV activated and may include thermographic technology.

In addition, the thickness of the shape may vary as indicated in step 24. It is contemplated that the thickness of the shapes can be reduced as a student becomes more familiar with reading the Arabic letters.

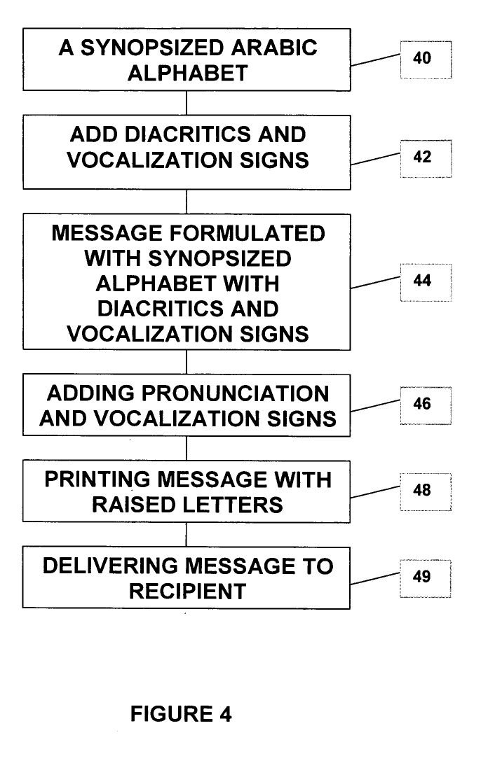

FIG. 4 is a block diagram that illustrates a method for communicating in Arabic by the visually impaired. The method includes the step 40 of synopsizing 82 shapes into 32 shapes which represent 28 basic letters of the Arabic alphabet. Diacritics and vocalization signs are added in step 42 and a message is created or formulated with the synopsized letters, diacritics and vocalization signs in step 44 and then entered into a computer in a conventional manner. Before or after entering the message into the computer, the print size is selected in step 46 in the same or similar manner to entering letter size in a conventional word processing program. The message is then printed with raised letters in step 48 and delivered to an intended recipient in step 49.

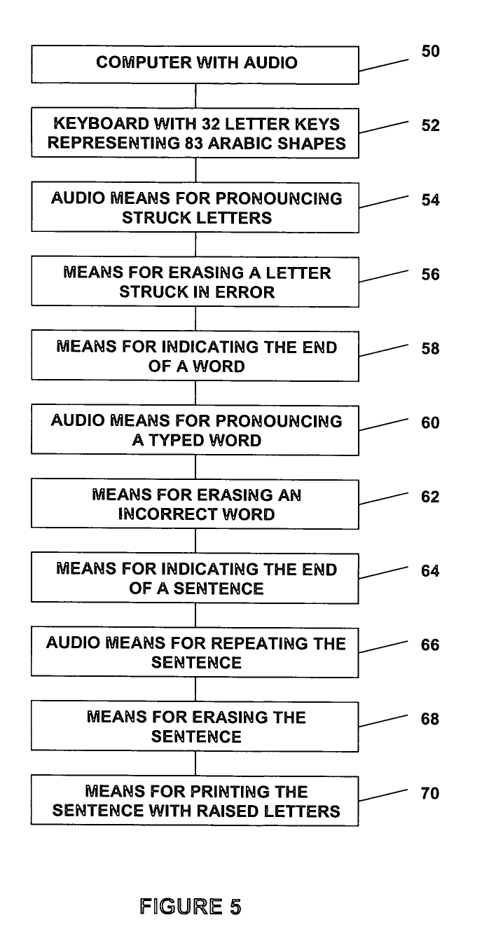

FIG. 5 is a block diagram of a system, apparatus or teaching aid for teaching Arabic to the visually impaired. As illustrated the apparatus includes a computer 50 with an audio output and a keyboard 52. The keyboard 52 includes a key for each of 32 synopsized shapes including diacritics and vocalization signs. Audio means 54 are also provided for pronouncing a letter when a key for producing that letter is struck. The audio means 54 is included in the computer software and well within the ability of a person of ordinary skill in the art.

The computer 50 also includes means 56 for erasing a letter which has been struck in error as for example a backspace key in a conventional word processing program. In addition, the keyboard also includes means 58 for indicating the beginning and end of a word and audio means 60 for pronouncing a typed word after typing an indication that the end of the word has been reached. The software can also be programmed to provide an audio indicator that a word is incomplete or misspelled after reading a word. A separate key on the keyboard may also be provided to activate program means 62 for erasing a word.

A preferred form of this embodiment of the invention also includes means 64 for indicating the end of a sentence and audio means 66 for repeating the sentence for a typist to hear. The software also includes means 68 for erasing a sentence for further editing of a message and finally printing means 70 for printing the message with raised letters.

While the invention has been described in connection with its preferred embodiments, it should be recognized that changes and modifications may be made therein without departing from the scope of the appended claims.

What is claimed is:

1. A method for teaching the Arabic language comprising the steps of:
synopsizing shapes of Arabic letters representing 28 basic letters into a preselected number of shapes;
consolidating the shapes into a plurality of groups according to shape in a first phase of a program;
adding indicia to the shape to distinguish each individual letter within a group in a second phase of the program;
adding pronunciation and vocalization signs in a third phase of the program; and,
using different marks to denote the start and end of a word.

2. A method for teaching Arabic to the blind comprising the steps of:
synopsizing 82 shapes representing 28 basic letters into 32 shapes;
consolidating the 32 shapes into 10 groups according to shape in a first phase of the program;
adding dots to the shapes to distinguish each individual letter within a group in a second phase of the program;
adding pronunciation and vocalization signs in a third phase of the program; and
using angles and/or curves to denote the start of or end of a word.

3. A method for teaching Arabic to the blind according to claim 2, which includes the step of optimizing the letters proportionally to conform with spatial visualization for the blind.

4. A method for teaching Arabic to the blind according to claim 3, in which letters coming at the end of a word include a tail angle looking to the left.

5. A method for teaching Arabic to the blind according to claim 4, in which the tail angle is embossed.

6. A method for teaching Arabic to the blind according to claim 2, in which said shapes are printed with a raised format.

7. A method for teaching Arabic to the blind according to claim 6, wherein a thickness of said shapes is varied depending on the tactile skill of an individual.

8. A method for teaching Arabic to the blind according to claim 2, in which the size of the shapes are the same at the start, in the middle, and at the end of a word or separate.

9. An Arabic teaching aid comprising a synopsized alphabet wherein 82 shapes representing 28 basic letters are synopsized into 32 shapes.

10. An Arabic teaching aid according to claim 9, in which the 32 shapes are separated into 10 groups.

11. An Arabic teaching aid according to claim 10, in which the 10 groups of shapes are as follows:

| Group | Lateefa Groups |
|---|---|
| 1^{st} | [symbol] |
| 2^{nd} | [symbol] |
| 3^{rd} | [symbol] |
| 4^{th} | [symbol] |
| 5^{th} | [symbol] |
| 6^{th} | [symbol] |
| 7^{th} | [symbol] |
| 8^{th} | [symbol] |
| 9^{th} | [symbol] |
| 10^{th} | [symbol] |

12. An Arabic teaching aid according to claim 11, in which said shapes are printed as raised letters.

13. An Arabic teaching aid according to claim 12, in which said shapes are printed in different sizes.

14. An Arabic teaching aid according to claim 9, in which said 32 shapes are three-dimensional.

15. An Arabic teaching aid according to claim 14, in which said shapes are provided in different sizes.

16. An Arabic teaching aid according to claim 9, in which the size of the shapes are the same at the start, in the middle and the end of a word or separate.

17. An Arabic typewriter and teaching aid for the blind comprising:
a keyboard having 32 “letter” keys representing a synopsized alphabet wherein 82 shapes representing 28 basic letters are synopsized into 32 shapes;
audio means for pronouncing a letter corresponding to a struck “letter” key and means for erasing a struck letter which was struck in error;
means for indicating the end of a word and audio means for pronouncing an ended word; and, means for erasing the ended word or printing the ended word.

18. An Arabic typewriter and teaching aid according to claim 17, which includes means for indicating the end of a sentence;
audio means for pronouncing the sentence; and, means for erasing the sentence or printing the sentence at the option of a typist.

19. An Arabic typewriter and teaching aid according to claim 18, which includes a computer for operation in response to keystrokes and a printer for printing inputted information in response to a command.

20. An Arabic typewriter and teaching aid according to claim 19, which includes means for printing raised letters.

21. A method for communication in Arabic that can be read and understood by the blind and the non-blind comprising the steps of:
synopsizing 82 Arabic shapes representing 28 basic letters into 32 shapes;
developing a message using the 32 shapes; and
printing the message using raised letters to be read by the blind or non-blind.

22. A method for communication in Arabic that can be read and understood by the blind and the non-blind according to claim 21, in which the 32 shapes are as follows:

[symbol]

[symbol]

[symbol]

[symbol]

[symbol]

[symbol]

[symbol]

[symbol]

[symbol]

[symbol]

[symbol]

[symbol]

[symbol]

23. A method for teaching Arabic to the blind comprising the steps of:
providing a computer and a keyboard with 32 letter keys representing 82 Arabic shapes;
providing an audio output for pronouncing a letter that corresponds to a struck key;
erasing a letter which has been struck in error;
indicating the end of a word or sentence; and,
printing the word or sentence in raised letters.

24. A method for teaching Arabic to the blind according to claim 23, which includes the step of pronouncing the word at the end of a word.

25. A method for teaching Arabic to the blind according to claim 24, which includes the steps of indicating the end of a sentence, pronouncing the sentence and erasing the sentence if incorrect.
